(19) United States
(12) Patent Application Publication
(10) Pub. No.: US 2005/0104830 A1
(43) Pub. Date: May 19, 2005

(54) Method and device for measuring drive current of thin film transistor array

(75) Inventors: Masayuki Kogure, Tokyo (JP); Yasuhiro Miyake, Tokyo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: AGILENT TECHNOLOGIES, INC.

(21) Appl. No.: 10/982,992

(22) Filed: Nov. 5, 2004

(30) Foreign Application Priority Data
Nov. 18, 2003 (JP) 2003-388608

(51) Int. Cl. G09G 3/36

(52) U.S. Cl. 345/92

(57) ABSTRACT

A measurement method for measuring a pixel drive signal of a TFT array comprising multiple pixels arranged in array form and an array drive current line for supplying the pixel drive current to each of these multiple pixels and wherein the array drive current flowing to this array drive signal line comprises this pixel drive current component and an offset current component, this measurement method characterized in that it comprises an array drive current measurement step wherein this array drive current when each of the pixels under test is driven is measured in succession for part or all of the pixels under test of these multiple pixels at a pre-determined time interval; an offset current measurement step wherein the above-mentioned offset current component is measured when this array drive current measurement step is not executed; an offset current calculation step wherein when this array current of a pixel under test is being measured, this offset current is calculated from these results of measuring multiple offset currents; and a pixel drive current calculation step wherein this pixel drive current of each of these multiple pixels is calculated from the difference between the measurement results of this array current measurement step and the calculation results of this offset current calculation step.

### BACKGROUND OF THE INVENTION

1. Field of the Invention

The present invention relates to a method and device for measuring the drive current of a thin film transistor (TFT) array, and in particular, to a method and device for measuring the drive current of a TFT array wherein the drive current has an offset component.

2. Discussion of the Background Art

There is a demand for flat display panels capable of responding to fast-moving images and reproducing vivid colors for flat-screen televisions, monitors of personal computers, the displays of portable telephones, and other flat-screen displays. In light of this demand, attention is being focused on active display panels that use thin film transistor (TFT) arrays with a fast response rate and self-emitting elements, such as organic EL elements with a broad display color range.

Self-emitting elements are light-emitting elements that emit light in response to the amount of current that flows to the element. Consequently, it must be possible to control the drive current of self-emitting elements that are used in a TFT array of a display panel. Therefore, it is necessary to check for the presence of a current and to measure the current or charge of a TFT array of a conventional liquid crystal panel when testing a TFT array for self-emitting elements.

Self-emitting materials, including organic EL materials, are expensive; therefore, the self-emitting material is generally inserted only into TFT arrays that have already passed the TFT array panel test. However, if the self-emitting material is not inserted, the material that will be driven is not present and the drive current does not flow. Therefore, there is a method wherein a dummy load capacity is set up in place of the self-emitting material and the current that flows to this load is measured in order test whether or not the current can be controlled.

A TFT panel 110 that uses a typical self-emitting material in which this type of load capacity has been set up is shown in FIG. 7. TFT panel 110 comprises pixels 120 arranged in an array, gate lines 112 and a data line 111 connected to each pixel, shift registers 115 and 116 connected to each gate line 112 and data line 111, a brightness signal line 113 that transmits brightness signals, and an array drive current line 114 that supplies pixel drive current to each pixel. Moreover, pixel 120 comprises a selection transistor 121 to which gate lines 112 and data line 111 are connected, a capacitor 122 connected to selection transistor 121, a pixel drive transistor 123 wherein capacitor 122 is connected to a gate electrode, and a load capacitor 124 in place of a self-emitting material, and this capacitor is connected to pixel drive transistor 123 and array drive signal line 114. This load capacitor 124 can be removed or left as is when the self-emitting material is sealed inside the TFT array panel.

The operation of TFT panel 110 will now be briefly described. Shift registers 115 and 116 apply voltage to specific gate lines 112 and data line 111. Pixel 120 is selected at this time and is located where there is an intersection between gate line 112 and data line 111 to which voltage has been applied. Next, voltage corresponding to the pixel drive current of selected pixel 120 is applied to brightness signal line 113. Brightness signals are transmitted to data line 111 that has been selected by a pixel selection circuit 104. Voltage is applied to the gate of selection transistor 121 and selected pixel 120 is turned ON (drain-source connection). Capacitor 122 is charged to a specific voltage by brightness signals supplied from data line 111. Thus, pixel drive transistor 123 is turned ON and current flows to load capacitor 124 from array drive signal line 114 in accordance with the voltage of capacitor 122.

Array drive signal line 114 is electrically connected to all of the pixels with this type of TFT array. Therefore, even if not all of the pixels are selected, array drive signal line 114 does not become zero and an offset current will flow due to the effects of leakage current in the pixels that are not selected and also residual current that continues to flow to pixel drive transistor 123 from the residual potential of capacitor 120. In addition, this offset current fluctuates with the status of the TFT array. Therefore, it is necessary to subtract the offset component from the measured array drive current in order to measure the pixel drive current of the TFT array.

The method whereby the array drive current is measured when each pixel is driven and when each pixel is not driven is a method for measuring with the offset component subtracted from the array drive current (refer to JP (Kokai) 200240074). A typical sequence of this method is shown in FIG. 3. First, the pixel under test of the TFT panel is selected (step 200). Then capacitor 122 is charged and the array drive current when the pixel is driven is measured (step 201). The array drive current (offset component) when the pixel under test is not driven, that is, when capacitor 122 is in a discharged state, is measured (step 202). Then, the pixel drive current is found from the difference between the array drive current when the pixel is driven and when the array drive current is not driven (offset component). Measurements are made continuously both when the pixel is not driven and when the pixel is driven on all pixels of the TFT panel (steps 204, 205).

FIG. 4 is a drawing showing the measurement points of the above-mentioned conventional technology. The x-axis in the drawing indicates time and the y-axis shows the array drive current. The pixel drive current of the first pixel becomes the difference between an array drive current 311 when the pixel is driven and an array drive current 301 when the pixel is not driven. Similarly, the pixel drive current of the 2nd through 4th pixel is the difference between currents 312, 313, and 314 when the pixel is driven and currents 302, 303, and 304 when the pixel is not driven. Thus, it becomes possible to precisely measure current, even if the offset current changes during the test, by measuring the offset component immediately after measuring each pixel.

However, when the array drive current is measured when each pixel is driven and when each pixel is not driven, it is necessary to measure each pixel twice. Therefore, there is a problem with long measurement time. It is possible to reduce to just one time the number of times the array drive current is measured with the pixel not being driven, but the calculations of the pixel drive current will not reflect the changes in the offset current that occur during measurement; thus, the accuracy of the measurement results will deteriorate.

In addition, when the offset current is measured successively during measurement of the array drive current during driving of multiple pixels, the timing of the measurement of each pixel will deviate from the intended timing. FIG. 5 shows the results of measuring the pixel drive current when the same pixel is continuously measured at the same time interval. By means of an ideal TFT array, the pixel drive current should be constant regardless of the measurement timing, but there is a transient quality to the current that drives the TFT array as shown in the figure, and it is clear that if the time interval at which the pixels are measured is different, there may be errors in the measurement results. This transient quality is not limited to when the same pixel is continuously measured and is a phenomenon that also occurs when pixels arranged linearly in the same column or same row, and the like are continuously measured. Therefore, it is preferred that pixels that are arranged linearly be continuously measured at the same time interval in order to obtain accurate measurement results.

### SUMMARY OF THE INVENTION

The above-mentioned problems are solved by a method for measuring a pixel drive current of a TFT array comprising multiple pixels arranged in array form and an array drive signal line for supplying pixel drive current to each of these multiple pixels and wherein the array drive current flowing to this array drive signal line comprises this pixel drive current component and an offset current component, this measurement method characterized in that it comprises an array drive current measurement step wherein the array drive current when each of the pixels under test is driven is measured in succession for part or all of the pixels under test of these multiple pixels at a pre-determined time interval; an offset current measurement step wherein the above-mentioned offset current component is measured when the array drive current measurement step is not executed; an offset current calculation step wherein when this array current of a pixel under test is being measured, the offset current is calculated from the results of measuring multiple offset currents; and a pixel drive current calculation step wherein the pixel drive current of each of these multiple pixels is calculated from the difference between the measurement results of this array current measurement step and the calculation results of this offset current calculation step.

### BRIEF DESCRIPTION OF THE DRAWINGS

FIG. 1 is a flow chart of the measurement method for the pixel drive current that is a working example of the present invention.

FIG. 2 is a schematic drawing of the device for measuring the pixel drive current and a TFT array of the working example of the present invention.

FIG. 3 is a flow chart of the prior art.

FIG. 4 is a waveform diagram of the array drive current of the prior art.

FIG. 5 is a drawing showing the transient quality of the pixel drive current.

FIG. 6 is the waveform drawing of the array drive current of a working example of the present invention.

FIG. 7 is a drawing showing a TFT panel that uses a typical self-emitting material.

### DETAILED DESCRIPTION OF THE PREFERRED EMBODIMENT

By means of the present invention, the pixel drive current of a TFT array can be measured very quickly and very precisely.

The method for measuring the pixel drive current of a TFT array that is the preferred embodiment of the present invention will be described in detail while referring to the attached drawings.

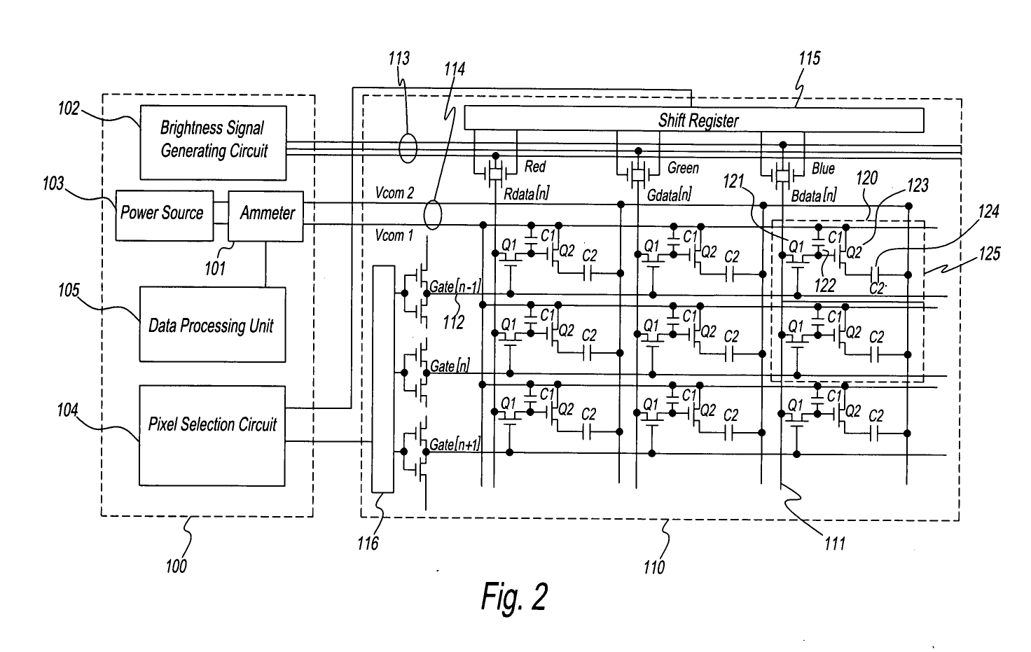

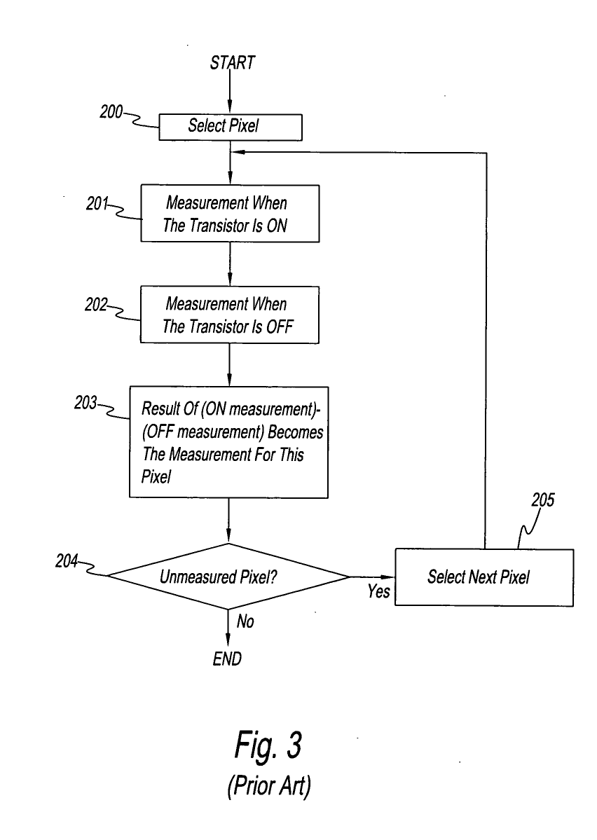

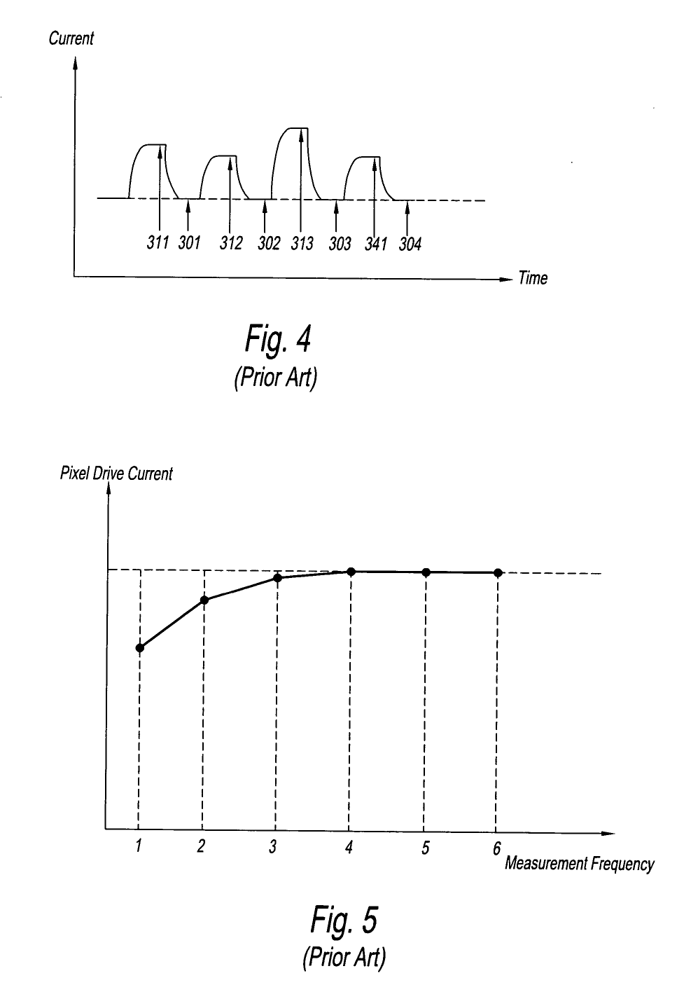

A schematic representation of the pixel drive current measurement device relating to the present invention and the circuit diagram of a TFT array 110 are shown in FIG. 2. A pixel drive current measurement device 100 comprises a pixel selection circuit 104 connected to shift registers 115 and 116, which perform pixel selection; a brightness signal generating circuit 102 connected to a brightness signal line 113; an ammeter 101, which is a measuring means connected to an array drive signal line 114; a power source 103, which is a drive current supply means connected to ammeter 101; and a data processing unit 105 connected to ammeter 101. A memory for storing measurement data and a processor for processing data are housed inside data processing unit 105. Pixels in 3,072 columns and 768 rows are arranged in matrix form. The structure of TFT array 110 is the same as described under the prior art and will therefore not be described again here.

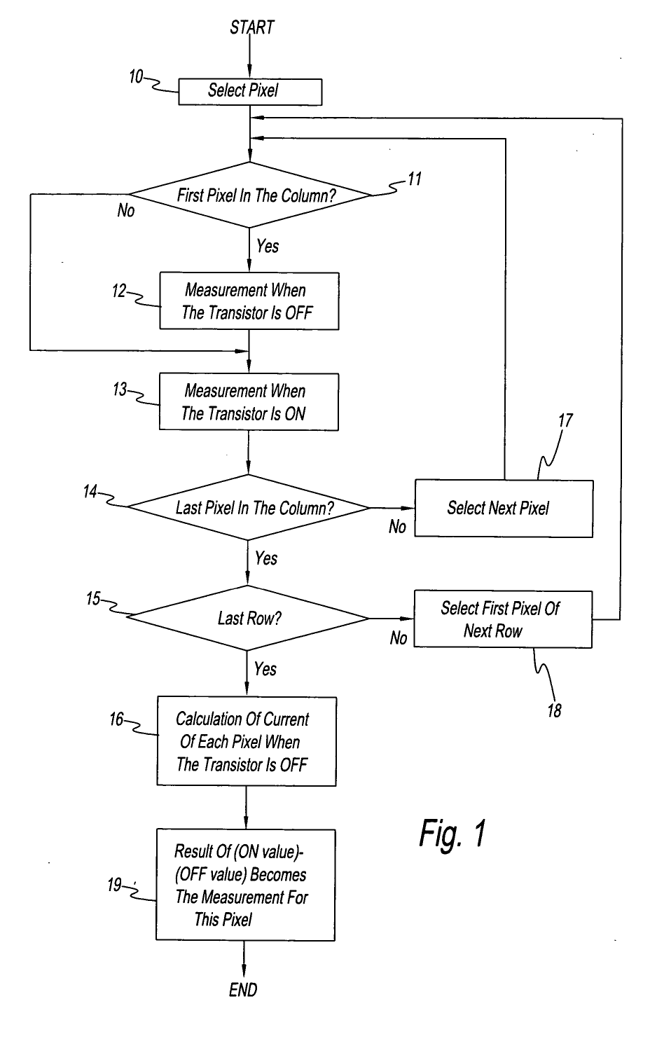

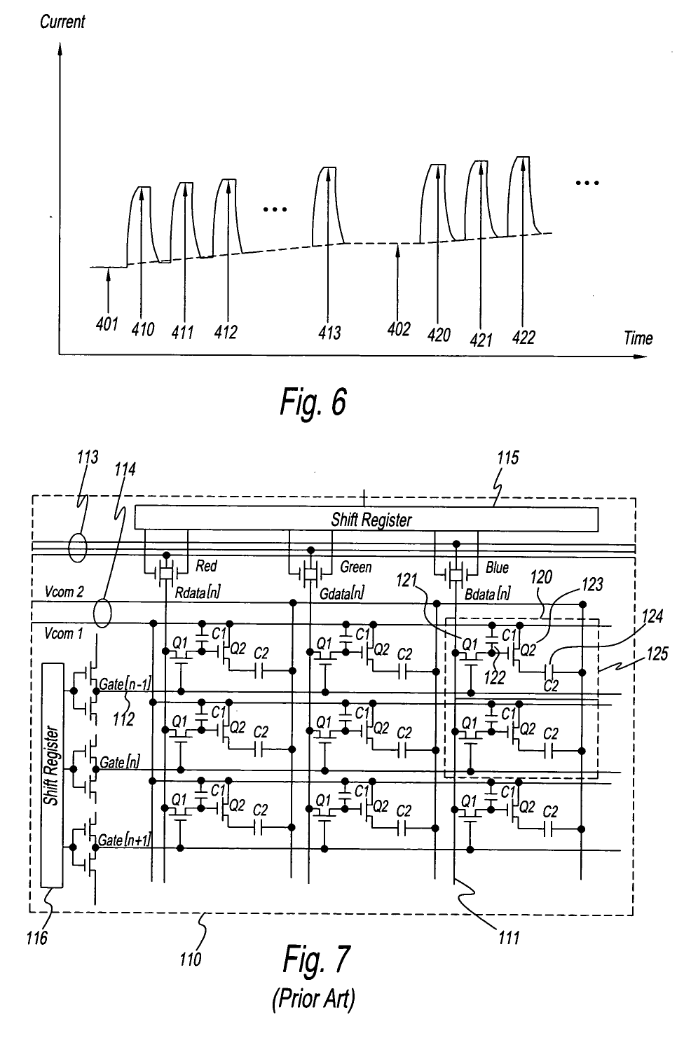

Next, the operation will be generally described based on the flow chart in FIG. 1, the structural drawing in FIG. 2, and the waveform graph of the array drive current in FIG. 6. First, pixel selector 104 selects pixel 120 of column 3, row 1 of the TFT array (step 10). The selected pixel is the first pixel of the column (step 11); therefore, the array drive current flowing to array drive current line 114 is measured at this time and recorded in the memory of data processing unit 105 (step 12). The current flowing at this time becomes the offset component 401 of the array drive current. Next, brightness signal generating circuit 102 outputs brightness signals to brightness signal line 113. Capacitor 122 of selected pixel 120 is charged to a specific voltage by this brightness signal, pixel drive transistor 123 is turned ON, and the pixel drive current corresponding to the brightness signals flows to array drive signal line 114. Current 410 at this time is measured by ammeter 101 and recorded in the memory of data processing unit 105 (step 13). After measurement, the current of array drive signal line 114 is brought to zero and the charge that has accumulated in capacitor 122 is discharged. The measurement of pixel 120 is thereby completed.

Pixel 120 is not the last pixel in the column (step 14). Therefore, the adjacent pixel 125 (column 3, row 2) is selected as the next pixel under test. Pixel 125 is not the first pixel of column 3 (step 11); therefore, the measurement of the offset current when the pixel drive transistor is OFF (step 12) is not performed and only array drive current 411 when the pixel is driven is measured (step 13). The sequence of the measurement is the same as with pixel 120. Pixels belonging to column 3 are similarly measured in succession. When the measurement of all pixels in column 3 is completed (step 15), the pixel in column 4, row 1 (not illustrated) is selected (step 18). Moreover, as with the measurement of column 3, the measurement of column 4 can be accomplished by measuring both the array drive current 402 when the pixel is not driven (offset current) only before the first pixel (column 4, row 1) is measured and the array drive current 420 when the pixel is driven (steps 12, 13). Thereafter, the pixels are measured in succession in the direction of the row, as with the measurement of column 3. However, the array drive current when the pixel is driven is only measured when the pixels are tested beginning with row 2. This measurement is repeated until pixels belonging to all of the columns in the TFT array have been measured and the measurement results are stored in the memory of data processing unit 105.

When the measurement of all pixels has been completed, data processing unit 105 calculates the offset current of each pixel. The offset current of pixels belonging to column 3 is calculated as follows. The offset current of pixel 120 of column 3, row 1 is array drive current 401 that was measured in step 12 when the pixel is not driven. The offset current of pixel 125 of column 3, row 2 is found by linear interpolation from offset current 402 that was measured in column 4 and offset current 401 that was measured in column 3. That is, the row number (2) of the pixel that is the subject of the offset current calculation is multiplied by the results of dividing the difference between offset current 402 measured for column 4 and offset current 401 measured for column 3 by the number of pixels belonging to column 3 (768) and offset current 401 is added to obtain the offset current. The offset current of all pixels is found in the same way (step 16). In the end, the pixel drive current of each pixel is found by subtracting the offset component found in step 16 from the measurement of the array drive current when the pixel is driven for each pixel (step 19).

Thus, the frequency of measurements can be reduced, making high-speed measurement possible, by measuring offset current each time the current is measured when a specific number of pixels are driven and not before each pixel is measured and calculating the offset current for each pixel by interpolation. Moreover, measurement of pixels belonging to a column in question can be performed in succession at the same time interval by setting up the timing for measuring offset current at the beginning or the end of each row; therefore, measurement errors due to the transient nature of the TFT array drive current are eradicated and precise measurement becomes possible.

It should be noted that although each column is measured in the present example, the same results will be obtained if each row is measured. Moreover, the offset current of each pixel of a TFT array where the offset component increases nonlinearly can be found by interpolation by means of a high-order function from the results of three of more offset current measurements. Furthermore, the tendency for changes in the offset current can be pre-determined when a TFT array with the same structure is measured multiple times under the same conditions, and therefore, it is possible to measure the offset current when the first pixel of the TFT array is measured and to calculate the offset current of each pixel from this measurement and the known trend for the changes and thereby reduce further the frequency of offset current measurement and curtail the measurement time.

1. A method for measuring a pixel drive current of a TFT array comprising multiple pixels arranged in array form and an array drive signal line for supplying the pixel drive current to each of said multiple pixels and wherein the array drive current flowing to said array drive signal line comprises said pixel drive current component and an offset current component, said method comprising:
an array drive current measurement step wherein said array drive current when each of the pixels under test is driven is measured in succession for part or all of the pixels under test of said multiple pixels at a pre-determined time interval;
an offset current measurement step wherein said offset current component is measured when said array drive current measurement step is not executed;
an offset current calculation step wherein, when this array current of a pixel under test is being measured, said offset current is calculated from said results of measuring multiple offset currents; and
a pixel drive current calculation step wherein said pixel drive current of each of said multiple pixels is calculated from the difference between the measurement results of said array current measurement step and the calculation results of said offset current calculation step.

2. The method according to claim 1, wherein each of said pixels under test belong to a specific column or row in this TFT array.

3. The method according to claim 1, wherein said offset current measurement step is executed before the array drive current measurement step.

4. The method according to claim 1, wherein said offset current measurement step is executed after the array drive current measurement step.

5. The method according to claim 1, wherein said offset current is calculated in this offset current calculation step by linear interpolation from the measurement results of the offset current measured immediately before and immediately after the array current of the pixel under test is measured.

6. A device for measuring the drive current of a TFT array, said device comprising:
a pixel selection signal generator with which signals that select a specific pixel of a TFT array are generated;
a drive current supply unit with which the drive current is supplied to multiple pixels of this TFT array;
a measurement unit with which said drive current is measured when said pixels are not driven and said drive current is measured when said multiple pixels are being driven at a specific time interval; and
a data processor with which the drive current of these pixels is calculated from said drive current when said multiple pixels are not driven and said drive current when these pixels are driven.

7. The device for measuring the drive current of a TFT array according to claim 6, wherein the multiple pixels that are subjected to said measurement of the drive current when the pixels are being driven by said measurement unit are arranged linearly.
